(19) United States
(12) Patent Application Publication
(10) Pub. No.: US 2026/0182732 A1
(43) Pub. Date: Jul. 2, 2026

(54) METHOD FOR MANUFACTURING BRUSHES AND BRUSH-MANUFACTURING DEVICE

(71) Applicant: Zahoransky AG, Todtnau (DE)

(72) Inventors: Marc KÖNIC, Wittnau (DE); Ingo KUMPF, Schlechtnau (DE); Florian KIEFER, Fröhnd (DE)

(73) Assignee: Zahoransky AG, Todtnau (DE)

(21) Appl. No.: 18/866,731

(22) PCT Filed: Feb. 23, 2023
(86) PCT No.: PCT/EP2023/054534

§ 371 Date: Nov. 18, 2024

(30) Foreign Application Priority Data
May 19, 2022 (EP) 22174320.6

(51) Int. Cl. A46D 3/04; B29C 65/14; B29L 31/42

(52) U.S. Cl. CPC A46D 3/045; B29C 65/1432; B29L 2031/425

(57) ABSTRACT

A method for manufacturing a brush (1) is provided, in particular a toothbrush, having a bristle carrier (2) and a bristle complement (3) of bristle filaments (4). The bristle carrier (2) and fastening-proximal ends (6) of the bristle filaments (4) of the bristle complement (3) are heated, and the fastening-proximal ends (6) of the bristle filaments (4)—as opposed to the bristle carrier (2)—are fused, whereupon the bristle carrier (2) and the bristle filaments (4) of the bristle complement (3) are connected to one another.

### CROSS-REFERENCE TO RELATED APPLICATIONS

This application is a 371 National Phase of PCT/EP2023/053534, filed Feb. 23, 2023, which claims priority to European Patent Application No. 22174320.6, filed May 19, 2022, both of which are incorporated herein by reference as if fully set forth.

### TECHNICAL FIELD

The invention relates to a method for manufacturing a brush, in particular a toothbrush, having a bristle carrier and a bristle complement of bristle filaments, and to a brush manufacturing device for manufacturing brushes, in particular toothbrushes.

### BACKGROUND

In the manufacturing of brushes, various methods for connecting the bristle carrier of a brush to a bristle complement of bristle filaments are known in practice. It is thus known, for example, that the bristle filaments of the bristle complement, which are combined to form bristle bundles, are fastened in receptacle holes of a bristle carrier by means of so-called anchors. In the process, the bristle bundles are punched into the receptacle holes conjointly with the anchors. However, for fastening bristle bundles in receptacle holes by means of anchors the bristle carriers must not fall short of a specific material thickness. If the bristle carrier has a deficient material thickness, the anchor technology for fastening the bristle bundles can no longer be applied in a reliable and meaningful way because there is too little available material in which the anchors can be fixed in this instance.

Alternatively, methods for fastening bristle filaments and bristle bundles of bristle filaments to bristle carriers without anchors are also known. In the process, bristle filaments and bristle carriers can be connected to one another in a materially integral manner, for example. The bristle filaments and the bristle carrier herein are at least partially fused and subsequently connected to one another. However, this approach also has its limits in the case of thin-walled bristle carriers because it is difficult to guarantee the dimensional accuracy of thin-walled bristle carriers in this method.

### SUMMARY

It is an object of the invention to provide a method for manufacturing brushes, in particular toothbrushes, and a corresponding brush manufacturing device, with improved performance characteristics by way of which the processing of thin-walled bristle carriers is also possible in a reliable manner.

In order to achieve the object, a method for manufacturing a brush, in particular a toothbrush is firstly proposed, which has one or more of the features directed toward a method of this type. In order to achieve the object, a method for manufacturing a brush, in particular a toothbrush, with a bristle carrier and a bristle complement of bristle filaments is thus in particular proposed, wherein the bristle carrier and fastening-proximal ends of the bristle filaments of the bristle complement are heated, and the fastening-proximal ends of the bristle filaments—as opposed to the bristle carrier—are fused, whereupon the bristle carrier and the bristle filaments of the bristle complement are connected to one another.

The method enables a reliable connection of the bristle filaments of the bristle complement to the bristle carrier of the brush, but without having to fuse the bristle carriers in the process. This can improve the dimensional accuracy of the bristle carrier and thus the quality of the manufactured brush. As a result, the method according to the invention is in particular also suitable for manufacturing brushes with delicate and thin-walled bristle carriers which to date have not been able to be manufactured by a method based on anchor technology, for example.

The invention is based on the concept that bristle carrier need not be fused in order to establish a reliable and preferably materially integral connection between the bristle filaments of the bristle complement and the bristle carrier of a brush. Instead, it is sufficient to only heat the fastening-proximal ends of the bristle filaments of the bristle complement to such a degree until the latter are fused. It is sufficient to only heat the bristle carrier and in this way prepare the latter for connecting to the bristle filaments of the bristle complement. In the process, it is not necessary to fuse the bristle carrier even in regions.

In the process, the bristle carrier and the fastening-proximal ends of the bristle filaments of the bristle complement are preferably heated to different temperatures. This can facilitate an energy-efficient implementation of the method, in particular when the bristle carrier is heated to a lower temperature than the fastening-proximal ends of the bristle filaments.

The bristle carrier and the bristle filaments of the bristle complement can be connected to one another in a materially integral manner. In this way, the bristle filaments of the bristle complement are fastened to the bristle carrier of the bristle complement in a particularly reliable and resilient manner. Moreover, in this type of fastening no structures are required on the bristle carrier for connecting the bristle carrier to the bristle complement in a materially integral manner, for example. This can simplify the manufacturing of the bristle carriers.

It is advantageous when the bristle carrier and the bristle filament are composed of materials which are compatible for a mutual materially integral connection, or are composed of the same material which is compatible for a mutual materially integral connection.

For manufacturing a brush which is particularly environmentally friendly, it can be advantageous when the bristle carrier and the bristle filaments, preferably all parts of the brush, are composed of a biologically decomposable material, in particular of a biologically decomposable plastics material, for example of polyamide, preferably of PA 10.10 or PA 12. The use of a material of this type for manufacturing the bristle carrier and the bristle filaments facilitates an environmentally friendly disposal, or ideally simple recycling, of the brush.

In particular when the bristle filaments and the bristle carrier are composed of different materials, it can be expedient for simplifying and/or improving the connection between the bristle filaments and the bristle carrier when bristle filaments and/or bristle carriers which contain at least one additive which functions as a bonding agent are used when carrying out the method.

In particular when the bristle filaments and the bristle carrier are composed of different materials, it can be expedient for simplifying and/or improving the connection between the bristle filaments and the bristle carrier when prior to connecting the bristle filaments to the bristle carrier a primer as a bonding agent is applied to the bristle filaments and/or the bristle carrier. The primer can serve as a bonding agent and simplify the production of a reliable connection between the bristle filaments and the bristle carrier. The primer can be applied as a lacquer.

For example, a bonding agent for plastics material, in particular for polypropylene, can be used as a primer and/or additive. For example, a bonding agent of the type PP-g-MAH can be used as a primer and/or additive. For example, the use of Priex 20097, Polybond 3200, Exelor PO 1020, Scona TPPP 8012, Scona TPPP 9012, Scona TPPP 9112, Licocene PP MA 6252 and/or Licocene PP MA 7452 as an additive and/or primer is possible.

For the connection of bristle filaments and/or bristle carriers which are composed of different plastics materials, for example of bristle filaments of polyamide (PA) or polybutylene terephthalate (PBT) and bristle carriers of polypropylene (PP), it can be advantageous to use such additives and/or primers that increase the grafts of the connection, in particular the plastics material connection, between the bristle filaments and the bristle carrier. The joining partner, thus the bristle carrier or the bristle filaments, that is composed of polypropylene is preferably modified by an additive and/or a primer. This can preferably be the bristle carrier because the latter is often composed of polypropylene.

Using the primers and/or additives mentioned above, it can be possible to connect a bristle carrier, which is composed of polypropylene, for example, to bristle filaments of another material, for example of polyamide or polybutylene terephthalate, without having also to fuse the bristle carrier for this purpose.

The use of an additive as a bonding agent can be particularly advantageous. An additive can be added to the raw material of which the bristle carrier and/or the bristle filaments are/is composed. In this way, it is possible to manufacture, for example to extrude and/or injection-mold, the bristle carrier and/or the bristle filaments directly from the raw material modified by the additives. A separate method step for subsequently applying a primer as a bonding agent to the bristle carrier and/or the bristle filaments can be avoided in this way. This facilitates an economical implementation of the method.

In one embodiment of the brush to be manufactured, the bristle carrier and/or the bristle filaments can be composed of, for example, polypropylene (PP), polybutylene terephthalate (PBP) and/or polyamide. By using a bonding agent mentioned above, thus an additive and/or a primer, when carrying out the method the bristle carrier and the bristle filaments can be connected to one another in a materially integral manner even when the materials are actually less suitable for a mutual materially integral connection, in particular for a welded connection or an adhesively bonded connection.

A materially integral connection in the context of the invention can in particular be a welded connection.

By fusing the fastening-proximal ends of the bristle filaments, at least one carrier plate can be generated which is composed of the fused filament material of the fastening-proximal ends of the bristle filaments. The at least one carrier plate can connect bristle filaments of one or a plurality of bristle bundles to one another. One carrier plate can also connect a plurality of bristle bundles, or all bristle bundles, of the bristle complement to one another. By fusing the fastening-proximal ends, the bristle filaments of one, or a plurality of, or all bristle bundles of the bristle complement can thus be connected to one another already prior to being connected to the bristle carrier. This can simplify manufacturing of the brush and in particular connecting the bristle complement to the bristle carrier.

In one preferred embodiment of the method, the bristle carrier is heated to a temperature below its melting temperature. It is ensured in this way that the bristle carrier does not even partially melt in any region. An undesirable deformation of the bristle carrier during connecting to the bristle filaments can be avoided, and the dimensional accuracy of the bristle carrier while carrying out the method can be ensured, in this way.

In particular when the bristle filaments and the bristle carrier are composed of the same material, the bristle carrier can be heated to a lower temperature than the fastening-proximal ends of the bristle filaments. In this way, the fastening-proximal ends of the bristle filaments can be fused and the bristle carrier only heated but not fused. This approach is particularly energy-efficient.

For connecting the bristle filaments to the bristle carrier, it can be expedient to insert the bristle carrier into a mold. The mold can have a mold wall that at least in portions laterally surrounds the bristle carrier, in particular a receptacle depression of the bristle carrier for the fastening-proximal ends of the bristle filaments. When connecting the bristle filaments of the bristle complement to the bristle carrier, the mold wall of the mold can guide fused filament material of the fastening-proximal ends of the bristle filaments in such a manner that it is avoided that fused filament material escapes by way of an external circumference of the bristle carrier. This approach facilitates maintaining an ideally smooth external contour of the bristle carrier without any offsets. Moreover, this variant of the method can be particularly suitable for manufacturing brushes which have particularly thin-walled bristle carriers. For connecting the bristle filaments to a thin-walled bristle carrier, the use of the mold can be advantageous for supporting the bristle carrier when connecting the bristle filaments to the bristle carrier. The mold can furthermore facilitate the dimensional accuracy of the bristle carrier when connecting the bristle filaments to the bristle carrier.

When the bristle carrier has a receptacle depression in which the bristle filaments are fastened to the bristle carrier by way of their fastening-proximal ends, this receptacle depression can be filled by the fused filament material of the fastening-proximal ends of the bristle filaments, and the bristle carrier can thus be reinforced and completed. This variant of the bristle carrier, or of the method for manufacturing a brush, allows brushes with bristle carriers of a particularly compact design to be provided.

A periphery of the bristle carrier that laterally delimits the above-mentioned receptacle depression can be supported by the mold and in particular the mold wall of the latter.

For connecting to the bristle carrier, the bristle filaments by way of their fused fastening-proximal ends can be pressed against the heated bristle carrier, or the heated bristle carrier can be pressed against the fused ends of the bristle filaments. A pusher of a brush manufacturing device can be used in the process. The fused fastening-proximal ends here are likewise still warm and preferably still fusible, but at least still soft and plastic, so that a good connection can be produced between the bristle carrier and the bristle filaments.

In order for a connection generated between the bristle carrier and the bristle filaments to set as fast as possible after connecting the bristle carrier to the bristle filaments, the bristle carrier can be cooled after connecting to the bristle filaments. This can take place with the aid of a cooling device of a brush manufacturing device explained in more detail hereunder, and/or by way of the previously mentioned mold.

Proposed for achieving the object is also a brush manufacturing device for manufacturing brushes, in particular toothbrushes, which has the features of the independent claim directed toward a brush manufacturing device of this type. As a result, the brush manufacturing device can be specified to carry out a method as claimed in one of the claims directed toward such a method.

According to the invention, the brush manufacturing device has a heating device which is specified to heat fastening-proximal ends of bristle filaments of a bristle complement and a bristle carrier to which the bristle filaments of the bristle complement are to be connected, and to fuse the fastening-proximal ends of the bristle filaments-as opposed to the bristle carrier.

The fastening-proximal ends of the bristle filament can be fused by heating with the brush manufacturing device, while the bristle carrier is only heated but not fused, and therefore remains dimensionally accurate.

In one preferred embodiment of the brush manufacturing device, the heating device comprises two heating areas. A first heating area of the two heating areas is provided for heating fastening-proximal ends of bristle filaments of a bristle complement of a brush to be manufactured, and a second heating area is provided for heating a bristle carrier of the brush to be manufactured, to which the bristle filaments of the bristle complement are to be connected. In this embodiment of the brush manufacturing device, the heating device by way of its two heating areas is specified to heat the fastening-proximal ends of the bristle filaments and the bristle carrier, and to fuse the fastening-proximal ends of the bristle filaments—as opposed to the bristle carrier.

The heating device, in particular by way of its two heating areas, is preferably specified to heat the fastening-proximal ends of the bristle filaments and the bristle carrier two different temperatures. This is advantageous when the bristle filaments and the bristle carrier have the same melting temperature, and only the fastening-proximal ends of the bristle filaments are to be fused.

The heating device can be specified, for example, to heat the heating areas to different temperatures. In this way it is possible to heat the fastening-proximal ends of the bristle filaments, on the one hand, and the bristle carrier of the brush to be manufactured, on the other hand, to different temperatures, and to carry out the method which has been explained in detail above.

The heating device can in particular be specified to heat the first heating area to a temperature that is sufficient to fuse the fastening-proximal ends of the bristle filaments. Furthermore, the heating device can be specified to heat the second heating area to a temperature that is sufficient to heat the bristle carrier to a temperature below its melting temperature. It is ensured in this way that the fastening-proximal ends of the bristle filaments are fused when using the brush manufacturing device, but the bristle carrier is heated but not fused, thus remaining dimensionally stable and dimensionally accurate.

In one embodiment of the brush manufacturing device it is provided that a spacing between the first heating area and a position which is predefined by the brush manufacturing device and in which the fastening-proximal ends of the bristle filaments are offered up for heating and for fusing, is larger than a spacing between the second heating area and a position which is predefined by the brush manufacturing device and in which the bristle carrier is offered up for heating. In this variant of the brush manufacturing device it is thus possible to heat the two heating areas of the heating device the same temperature. As a result of the different spacings between the positions predefined by the brush manufacturing device, in which the fastening-proximal ends of the bristle filaments, on the one hand, and the bristle carrier, on the other hand, are offered up and the respective heating area, the desired, optionally different degree of heating of the fastening-proximal ends of the bristle filaments and of the bristle carrier can be ensured.

In a particularly compact embodiment of the brush manufacturing device it is provided that the two heating areas are disposed on a common heating element, in particular on different sides of the common heating element, preferably on sides of the heating element that faces away from one another. In this way, the heating element can be positioned between the offered-up bristle carrier, on the one hand, and the offered-up fastening-proximal ends of the bristle filaments, on the other hand.

For carrying out the method explained above it can be expedient when the heating device is specified to preferably independently feedback-control the temperatures of the two heating areas. The heating device here can have a control unit and at least one temperature sensor for detecting and feedback-controlling the temperature of at least one of the two heating areas. Each heating area is preferably assigned at least one temperature sensor. In this way to is possible to detect and individually monitor the temperatures of the two heating areas of the heating device independently of one another, and to optionally adapt said temperatures with the aid of the control unit of the brush manufacturing device if a variance between the actual temperature of the heating areas and a target temperature of the heating areas is established.

The brush manufacturing device can have a mold for receiving and supporting the bristle carrier when connecting the bristle carrier to the bristle filaments of the bristle complement. The advantages of a mold of this type have already been explained in the context of the method. The use of a mold of this type is particularly suitable for processing thin-walled bristle carriers.

The brush manufacturing device can have a dispensing device for dispensing primer onto bristle filaments and/or bristle carriers. In this way, primer can be dispensed onto bristle filaments and/or bristle carriers before the bristle filaments are connected to the bristle carriers. A primer can facilitate the production of a reliable connection between bristle filaments and bristle carriers.

The brush manufacturing device can furthermore have a filament holder for holding, in particular in a clamping manner, the bristle filaments of the bristle complement. With the aid of the filament holder it is possible to hold the filaments of the bristle complement by way of the fastening-proximal ends thereof in the position already mentioned above on the first heating area of the heating device, so as to heat the fastening-proximal ends of the bristle filaments and ultimately fuse the latter. The filament holder can also be used for guiding the bristle filaments of the bristle complement when connecting the bristle filaments to the bristle complement. In the process, the bristle filaments, in particular by way of a cleaning side of the bristle complement, can be axially impinged in terms of the longitudinal axes thereof and pressed against the heated bristle carrier. For this purpose, the brush manufacturing device can have a pusher which is specified to press bristle filaments of the bristle complement by way of their fused fastening-proximal ends against the heated bristle carrier, so as to connect the bristle filaments to the bristle carrier in this way. The pusher can also be specified to press a heated bristle carrier against fused ends of bristle filaments, so as to connect the bristle carrier and the bristle filaments to one another.

Furthermore, it is advantageous when the filament holder has a hole pattern of receptacle holes, which are preferably formed as passage holes, for the bristle filaments and/or bristle bundles of the bristle complement of bristle filaments.

If the receptacle holes of the filament holder are formed as passage holes, the bristle filaments and/or bristle bundles located in the receptacle holes can be pushed out of the receptacle holes in an axial movement in terms of the longitudinal axes of said bristles so as to press the fused fastening-proximal ends of the bristle filaments against the heated bristle carrier, and to connect the bristle filaments to the bristle carrier.

The filament holder can be designed as a cassette, for example, and/or be transportable between individual stations of the brush manufacturing device.

The filament holder can furthermore have a clamping mechanism by way of which the bristle filaments of the bristle complement can be fixed in the receptacle holes of the filament holder. The clamping mechanism can be closed during heating and fusing of the fastening-proximal ends of the bristle filaments, so that the bristle filaments can be held in a reliable and positionally accurate manner in the filament holder.

As soon as the fastening-proximal ends of the bristle filaments have been fused and the bristle carrier has been heated, the clamping mechanism of the filament holder can be opened. When the clamping mechanism of the filament holder is opened, the bristle filaments of the bristle complement by way of their fused fastening-proximal ends can be pressed against the heated bristle carrier, for example with the aid of the already previously mentioned pusher of the brush manufacturing device, so as to connect the bristle filaments to the bristle carrier.

In order to reduce the process time required for producing the connection between the bristle filaments and the bristle complement and, above all, for said connection to set, it is advantageous when the brush manufacturing device has a cooling device. The cooling device can be specified to cool down the bristle carrier after it has been connected to the bristle filaments. For example, the cooling device can act by way of the previously already mentioned mold of the brush manufacturing device on the bristle carrier placed in the latter.

The brush manufacturing device can furthermore have a magazine for receiving a supply of loose bristle filaments. The brush manufacturing device, downstream of the magazine, can comprise a bundle separating device which is specified to pick bristle bundles of bristle filaments from the supply of loose bristle filaments contained in the magazine and to offer up said bristle bundles for assembling a bristle complement.

The brush manufacturing device can furthermore have a bundle forming unit which is specified to transform the bristle bundles picked from the bristle magazine into a target shape desired for manufacturing the brushes.

The bristle bundles can be transferred from the bundle forming unit to the filament holder already mentioned above. In the filament holder, the bristle bundles can then be held in a mutual relative arrangement which said bristles also later assume in the bristle complement of the brush to be manufactured.

### BRIEF DESCRIPTION OF THE DRAWINGS

The invention will be explained in more detail hereunder by means of an exemplary embodiment. The invention is not limited to the exemplary embodiment shown in the figures. Further exemplary embodiments of the invention are derived by combining the features of individual claims and/or by combining the features of the exemplary embodiment shown. In the figures:

FIGS. 1 to 4 show different views of a brush designed as a toothbrush, wherein it can be seen that a bristle carrier of the brush has a receptacle depression for receiving the fastening-proximal ends of bristle filaments of a bristle complement of the brush, said receptacle depression being filled by fused filament material after the bristle filaments has been fastened to the bristle carrier;

FIG. 5 shows a perspective view of the bristle complement of the brush shown in FIGS. 1 to 4, after fusing the fastening-proximal ends of its bristle filaments;

FIGS. 6 to 9 show different views of a further embodiment of a comparable brush, the receptacle depression of the latter for receiving a bristle complement being penetrated by a structure of reinforcement ribs;

FIG. 10 shows a perspective view of the bristle complement of the brush shown in FIGS. 6 and 9, after fusing the fastening-proximal ends of its bristle filaments;

FIG. 11 shows a schematic illustration of parts of a brush manufacturing device for manufacturing the brushes illustrated in the preceding figures; and

FIGS. 12 to 14 show further parts of the brush manufacturing device for visualizing a method for manufacturing the brushes which are at least partially shown in FIGS. 1 to 10.

### DETAILED DESCRIPTION

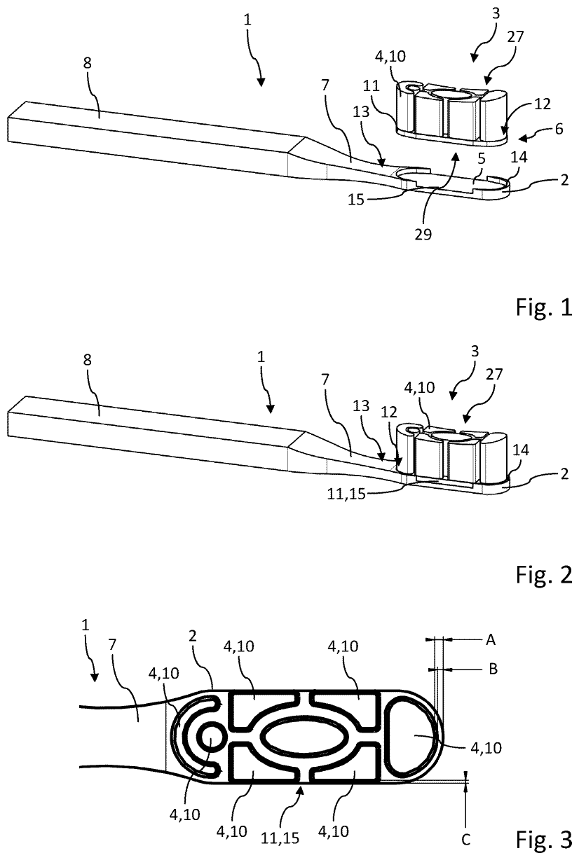

FIGS. 1 to 5, and 6 to 10, show at least parts of a brush which is in each case overall identified by the reference sign 1 and is designed as a toothbrush. Unless otherwise explicitly mentioned, the explanations hereunder refer to both embodiments of the brush 1 shown in the figures.

The brush 1 has a bristle carrier 2, specifically a brush head to which a bristle complement 3 of bristle filaments 4 is fastened.

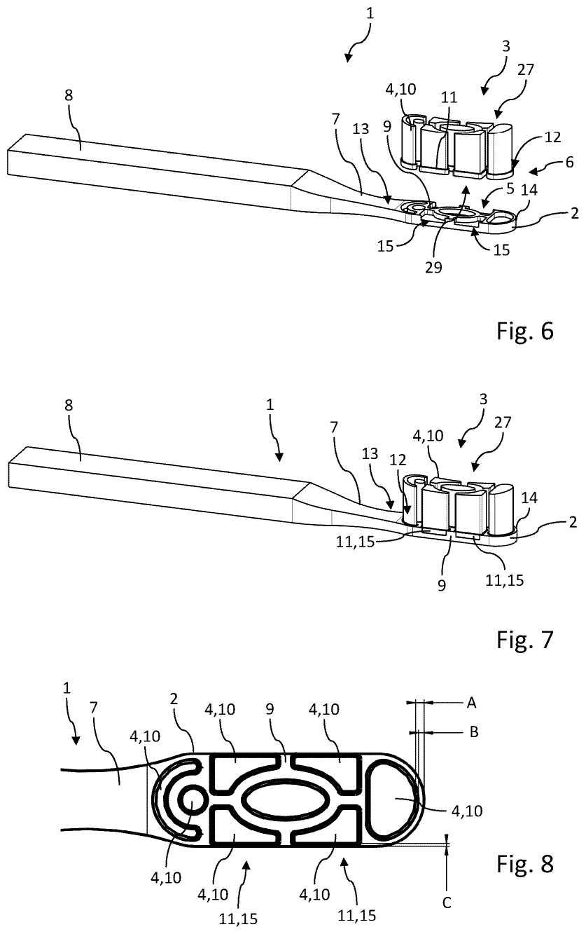

FIGS. 1 and 6, for example, highlight that the brush 1 has a receptacle depression 5 on its bristle carrier 2. Bristle filaments 4 are fastened in the receptacle depression 5 by way of their fastening-proximal ends 6. On the finished brush 1, the receptacle depression 5 is filled by filament material of the fastening-proximal ends 6 that has been fused for fastening the bristle filaments 4. The bristle carrier 2, specifically the brush head, is connected to a handle 8 of the brush 1 by way of a neck portion 7 of the brush 1. FIGS. 1 and 4, for example, show that the bristle carrier 2, prior to fastening the bristle filaments 4 in the region of the receptacle depression 5 has its smallest material thickness able to be measured in the direction of a normal onto the receptacle depression 5. The bristle carrier 2 is of a thicker design in adjacent regions. This is shown in FIGS. 4 and 9, for example, in which the material thickness E in the region of the receptacle depression 5, and the material thickness D in adjacent portions of the bristle carrier 2, are highlighted by schematic dimensions.

After fastening the bristle filaments 4 to the bristle carrier 2, the bristle carrier 2 as a result of the fused filament material of the bristle filament 4 is reinforced in the region of its filled receptacle depression 5.

In the exemplary embodiment of a brush 1 shown in FIGS. 6 to 10, reinforcement ribs 9 are formed within the receptacle depression 5 which impart the bristle carrier 2, despite its relatively minor material thickness E, good stability in the region of the receptacle depression 5. This can simplify the handling of the bristle carrier 2 in the manufacturing of the brush 1.

The receptacle depression 5 is segmented as a result of the reinforcement ribs 9 present within the receptacle depression 5. The arrangement of reinforcement ribs 9 generates a pattern of individual receptacles which in terms of shape and arrangement corresponds to a cross-sectional shape and arrangement of bristle bundles 10 of the bristle complement 3 that consist of bristle filaments 4.

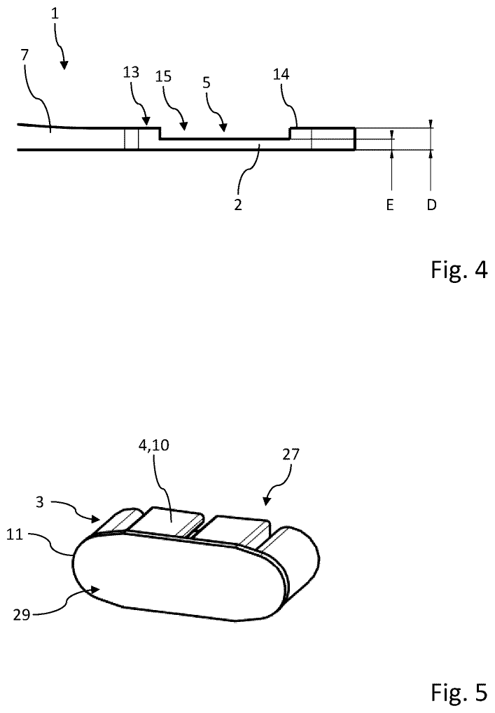

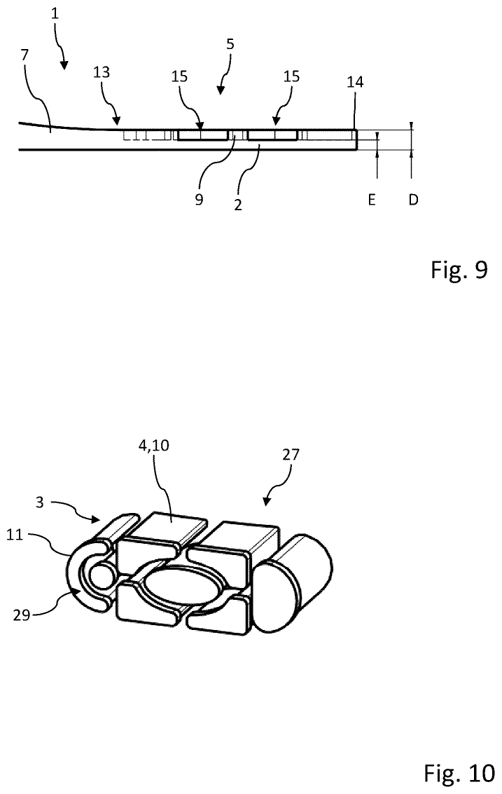

FIGS. 5 and 10 highlight that the fused filament material of the respectively shown bristle complement 3 forms at least one carrier plate 11 which fills the receptacle depression 5 of the respective brush 1 after the bristle filaments 4 have been fastened to the bristle carrier 2.

The bristle filaments 4, or the bristle bundles 10 formed from the bristle filaments 4, can be connected to one another by the carrier plate 11. This is the case in particular in the carrier plate 11 shown in FIG. 5.

In the bristle complement 3 shown in FIG. 10, the bristle filaments 4 within one bristle bundle 10 are connected by one carrier plate 11. Each of the total of eight bristle bundles 10 bus has one carrier plate 11.

The carrier plate 11 fills the receptacle depression 5 in such a manner that a surface 12 of the carrier plate 11 is flush with a brush surface 13 of the brush 1 that is contiguous to the receptacle depression 5 and the bristle complement 3. In an analogous manner, the plurality of carrier plates 11 of the bristle complement 3 shown in FIG. 10 also fill the parts of the receptacle depression 5 of the bristle carrier 2 shown in FIGS. 6 to 9 that is segmented by the reinforcement ribs 9. Here too, surfaces 12 of the carrier plates 11 are then flush with a brush surface 13 of the brush 1 that surrounds the receptacle depression 5.

The bristle filaments 4 and the bristle carrier 2, as well as the neck portion 7 and the handle 8 of the brush 1, are composed of the same material which moreover permits a materially integral connection between the bristle filaments 4 and the bristle carrier 2.

The brushes 1 shown in the figures are thus so-called single-material brushes. Because a biologically decomposable plastics material, for example polyamide, specifically preferably PA 10.10 or PA 12, is used as a material for manufacturing the bristle carrier 2, the neck portion 7 and the handle 8, as well as the bristle filaments 4 of the bristle complement 3 of the brush 1, the brush 1 is particularly environmentally friendly and is easy to recycle.

The bristle filaments 4, which are fastened in the receptacle depression 5, and the bristle carrier 2, after connecting form a materially homogenous monolithic unit and are connected to one another in a materially integral manner.

The bristle carrier 2 has a periphery 14 which laterally limits the receptacle depression 5. When connecting the bristle filaments 4 to the bristle carrier 2, the periphery 14 serves to guide the fused filament material in such a manner that the receptacle depression 5 is filled with the fused filament material of the fastening-proximal ends 6 of the bristle filaments 4.

A plurality of cutouts 15, which are filled by the fused filament material of the fastening-proximal ends 6 of the bristle filaments 4 so as to be preferably flush with adjacent peripheral portions, are in each case formed in the periphery 14. This is highlighted in FIG. 3, for example, which shows a plan view of the bristle carrier 2 designed as a brush head of the one brush 1.

It can be seen from this illustration that the cutouts 15 in the periphery 14 are almost completely filled with the fused filament material of the fastening-proximal ends 6 of the bristle filaments 4.

FIGS. 3 and 8 show that the bristle complement 3 on the finished toothbrush, in a region in which the bristle complement 3 is disposed adjacent to the periphery 14 of the bristle carrier 2 that delimits the receptacle depression 5, can have a spacing A of 0.5 mm to 3 mm from a circumference of the bristle carrier 2, for example. In this case, the spacing A also defines the spacing of the bristle bundles 10 from the circumference of the bristle carrier 2.

FIGS. 3 and 8 also show that the fused filament material, and thus the carrier plate 11, where said filament material and the carrier plate 11 are surrounded by the periphery 14 of the bristle carrier 2 can have a spacing B of, for example, 0.3 mm to 2 mm from the circumference of the bristle carrier 2. In this case, the spacing B also defines the peripheral thickness of the periphery 14 of the bristle carrier 2 that delimits the receptacle depression 5 and bears on the carrier plate 11.

FIGS. 3 and 8 furthermore show that the fused filament material, and thus the carrier plate 11, in the region of a cutout 15 in a periphery 14 of the bristle carrier 2 that surrounds the receptacle depression 5 can have a spacing C of, for example, 0 mm to 2 mm from the circumference of the bristle carrier 2. The fused filament material which forms the carrier plate 11, in the region of a cutout 15 in the periphery 14, can thus extend completely toward the outside, fill the cutout 15 and terminate so as to be flush with contiguous peripheral portions.

FIGS. 4 and 9 show that the bristle carrier 2 on the periphery, and after fastening the bristle filaments 4 to the bristle carrier 6, can have a material thickness D of 2 mm to 6 mm. The material thickness D herein defines the thickness of the head of the bristle carrier.

FIGS. 4 and 9 furthermore show that a material thickness E in the region of the receptacle depression 5, prior to fastening the bristle filaments 4 to the bristle carrier 2, in the case of toothbrushes can be, for example, 1 mm to 4 mm. the difference between the variables D and E in this case defines the height of the periphery 14 above the receptacle depression 5.

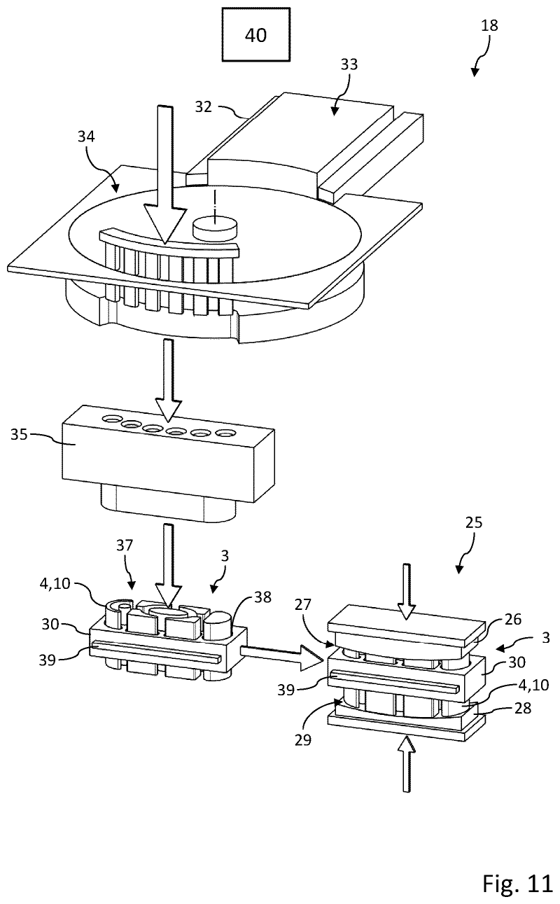

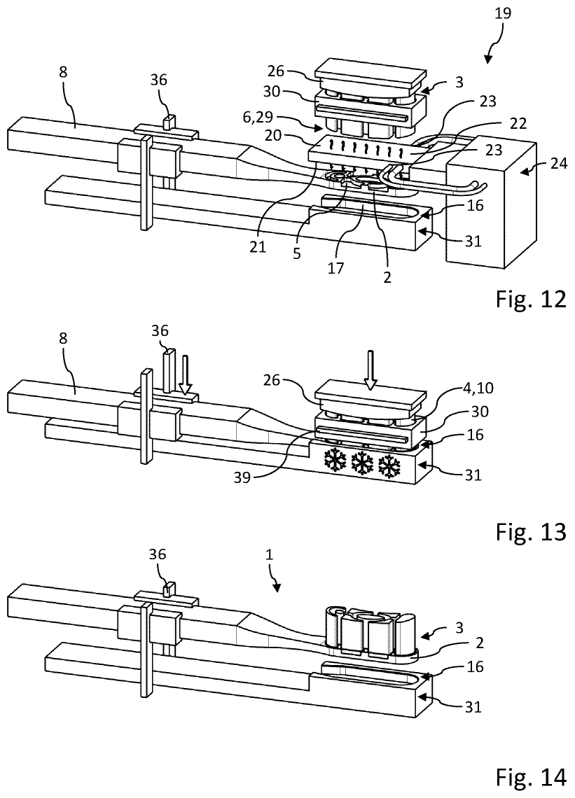

FIGS. 11 to 14 visualize a method for manufacturing a brush 1 as is at least partially illustrated in FIGS. 1 to 9. FIG. 12 shows that firstly the fastening-proximal ends 6 of the bristle filaments 4, and the bristle carrier 2, are heated for connecting the bristle filaments 4 to the offered-up bristle carrier 2. In the process, the fastening-proximal ends 6 of the bristle filaments 4—as opposed to the bristle carrier 2—are fused. Subsequently, the bristle carrier 2 and the bristle filaments 4 of the bristle complement 3 are connected to one another.

When fastening the bristle filaments 4 to the bristle carrier 2, the previously mentioned receptacle depression 5 of the bristle carrier 2 is filled by filament material of the fastening-proximal ends 6 of the bristle filaments 4 that has been fused for this purpose. FIG. 12 furthermore shows that not only the fastening-proximal ends 6 of the bristle filaments 4, but also the bristle carrier 2 in the region of its receptacle depression 5, is heated in a contactless manner by means of thermal radiation in the process.

The fastening-proximal ends 6 of the bristle filaments 4 and the bristle carrier 2 are heated to different temperatures and connected in a materially integral manner. Specifically, the fastening-proximal ends 6 of the bristle filaments 4 are heated to a higher temperature than the bristle carrier 2 in the method. While the fastening-proximal ends 6 of the bristle filaments 4 are heated to such a degree that they melt, the temperature to which the bristle carrier 2 in the region of its receptacle depression 5 is heated is chosen to be lower so that the bristle carrier 2 does not melt. The temperature to which the bristle carrier 2 is heated in the process lies below its melting temperature. After fastening to the bristle carrier 2, the bristle filaments 4 and the bristle carrier 2 are connected to one another in a materially integral manner and form the materially homogenous monolithic unit already mentioned above. This is possible because the bristle carrier 2 and the bristle filaments 4 are composed of the same material which is compatible with a mutual materially integral connection.

In order to simplify and/or improve the connection between the bristle filaments 4 and the bristle carrier 2, the bristle filaments 4 and/or the bristle carrier 2 contain/contains at least one additive which functions as a bonding agent. Furthermore, prior to connecting the bristle filaments 4 to the bristle carrier 3, a primer as a bonding agent can be applied to the bristle filaments 4 and/or the bristle carrier 2.

A primer which is applied to the bristle carrier 2 and/or the bristle filaments 4, and/or an additive which can be added to the material of which the bristle carrier 2 and/or the bristle filaments 4 are composed, for example, can simplify the production of a reliable connection between the bristle filaments 4 and the bristle carrier 2.

The use of such additives and/or primers that increase the grafts of the connection, in particular of the plastics material connection between the bristle filaments 4 and the bristle carrier 2 is advantageous. In this way, the bristle carriers 2 and bristle filaments 4 which are composed of different materials can also be reliably connected by the method described. For example, bristle carriers 2 made of polypropylene can thus be connected to bristle filaments 4 which are composed of, for example, polyamide or else of polybutylene terephthalate, with the aid of additives and/or primers.

When carrying out the method, at least one carrier plate 11 which connects the bristle filaments 4 of one or a plurality of bristle bundles 10 and/or a plurality of bristle bundles 10, or all bristle bundles 10, of the bristle complement 3 to one another is generated by fusing the fastening-proximal ends 6 of the bristle filaments 4.

When fastening the bristle filaments 4 to the bristle carrier 2, the cutouts 15, which are present in the periphery 14 of the bristle carrier 2 that laterally delimits the receptacle depression 5, are filled by the filament material of the fastening-proximal ends 6 of the bristle filaments 4 so as to be preferably flush with contiguous peripheral portions.

For fastening the bristle filaments 4 in the receptacle depression 5, the bristle carrier 2 is inserted into a mold 16. The mold 16 has a mold wall 17 which laterally surrounds the receptacle depression 5 of the bristle carrier 2 in such a manner that the periphery 14 of the bristle carrier 2, which laterally delimits the receptacle depression 5, is laterally supported.

According to FIG. 13, the bristle carrier 2 is inserted into the mold 16 once the fastening-proximal ends 6 of the bristle filaments 4 and the bristle carrier 2 have been heated. Inserting the bristle carrier 2 is performed by a lifting device 36 of a brush manufacturing device 18 which is explained in more detail hereunder.

After fastening the bristle filaments 4 to the bristle carrier 2, and after filling the receptacle depression 5 by the filament material of the fastening-proximal ends 6 of the bristle filaments 4, the bristle carrier 2 is cooled by way of the mold 16. A connection between the bristle filaments 4 and the bristle carrier 2 sets in the process.

A brush manufacturing device which overall is identified by the reference sign 18 is used for carrying out the method. The brush manufacturing device 18 has a heating device 19. The heating device 19 comprises two heating areas 20 and 21, of which a first heating area 20 is provided for heating and for fusing fastening-proximal ends 6 of bristle filaments 4, and a second heating area 21 is provided for heating a bristle carrier 2. In the process, the heating areas 20 and 21 dispense the heat to the bristle filaments 4, or to the bristle carrier 2, by way of thermal radiation.

The heating device 19, by way of its two heating areas 20 and 21, is specified to heat the fastening-proximal ends 6 of the bristle filaments 4 and the bristle carrier 2, and in the process to fuse the fastening-proximal ends 6—as opposed to the bristle carrier 2. The bristle carrier 2 remains dimensionally accurate because it is not heated to the degree of melting.

The heating device 19 is specified to heat the two heating areas 20 and 21, and by way of the latter the fastening-proximal ends 6 of the bristle filaments, and the bristle carrier 2 in the region of its receptacle depression 5, to different temperatures. The heating area 20 in the process can be heated to a temperature which is sufficient to fuse the fastening-proximal ends 6 of the bristle filaments 3 by means of thermal radiation.

The two heating areas 20 and 21 are disposed on a common heating element 22, and herein on different sides of the heating element 22, specifically on sides that face away from one another.

In this way it is possible to position the heating element 22 in its position shown in FIG. 12, between an offered-up bristle carrier 2 and offered-up bristle filaments 4, so as to heat the fastening-proximal ends 6 of the bristle filaments 4 by way of the heating area 20, and the bristle carrier 2 by way of the heating area 21.

The heating device 19 is specified to independently feedback-control the temperatures of the two heating areas 20 and 21. For detecting and feedback-controlling the temperatures of the two heating areas 20 and 21, the heating device 19 comprises in each case at least one temperature sensor 23 for each of the heating areas 20 and 21.

With the aid of the temperature sensors 23 it is possible to detect the temperatures of the heating areas 20 and 21 and in this way perform feedback-controlling of the temperatures of the two heating areas 20 and 21 to a target temperature. For carrying out the temperature feedback-control of the heating areas 20 and 21, the heating device 19 is equipped with a corresponding control unit 24. The control unit 24 is connected to the temperature sensors 23 and can adapt the temperatures of the heating areas 20 and 21 as a function of a variance of a respective actual temperature from a target temperature of the heating areas 20, 21 detected by the temperature sensors 23.

The mold 16 already mentioned above is part of the brush manufacturing device 18. The mold 16 serves to receive and support the bristle carrier 2 when fastening the bristle filaments 4 to the bristle carrier 2. For fastening the bristle filaments 4 in the receptacle depression 5 after heating and fusing the fastening-proximal ends 6 of the bristle filaments 4, and after heating the bristle carrier 2 without fusing the latter, the bristle carrier 2 is lowered into the mold 16 by the lifting device 36 of the brush manufacturing device 18.

The brush manufacturing device 18 also comprises a profiling device 25. The profiling device 25 is shown in FIG. 11 and partially in FIGS. 12 and 13. The profiling device 25 serves to profile the bristle complement 3 of the brush 1 to be manufactured.

The profiling device 25 has a profiling tool 26 for profiling a cleaning side 27 of the bristle complement 3, and a counter-profiling tool 28 for supporting and profiling a fastening side 29 of the bristle complement 3.

The functional mode of the profiling device 25 becomes evident from FIG. 11, for example. Accordingly, the profiling tool 26, by way of its shape-imparting convexly shaped surface, is moved toward the cleaning side 27 of the bristle complement 3. As a result, the bristle filaments 4 are axially displaced in terms of their longitudinal axis, according to the shape of the profiling tool 26. The bristle filaments 4 are supported and brought into shape by the counter-profiling tool 28 which is placed on the fastening side 29 of the bristle complement 3, the surface of said counter-profiling tool 28 having a contour which is concavely shaped and corresponds to the target contour of the bristle complement 3 on its cleaning side 27.

The different protrusion of the bristle filaments 4 on the fastening side 29 of the bristle complement 3 is equalized when fusing the fastening-proximal ends 6 of the bristle filaments 4 for fastening the bristle filaments 4 to the bristle carrier 2 of a brush 1 to be manufactured.

FIG. 11 shows that the brush manufacturing device 18 moreover has a filament holder 30 with a clamping mechanism 39 for holding the bristle filaments 4 of the bristle complement 3 in a clamping manner. The filament holder 30 is designed as a cartridge and can be moved from one station to another station of the brush manufacturing device 18, and hold the bristle filaments 4 when profiling the bristle complement 3 and likewise when heating and fusing their fastening-proximal ends 6 on the heating device 19. The filament holder 30 has a hole pattern 37 of receptacle holes 38 for bristle bundles 10 of bristle filaments 4, which corresponds to a bundle arrangement of bristle bundles 10 in the bristle complement 3.

The filament holder 30 is also used when pressing the fastening-proximal ends 6 of the bristle filaments 4 into the receptacle depression 5 of an offered-up bristle carrier 2. However, the clamping mechanism 39 of said filament holder 30 herein is opened. In this way, the bristle filaments 4, by way of their fastening-proximal ends 6, can be pressed into the receptacle depression 5 and in the process against the heated bristle carrier 2, with the aid of the profiling tool 26 which axially impinges the bristle filaments 4 on the fastening side 27 of the bristle complement 3. In the process, the bristle filaments 4 are guided by the filament holder 30 and its continuous receptacle holes 38. In this instance, the profiling tool 26 functions as a pusher of the brush manufacturing device 18 and enables the bristle carrier 2 to be connected to the bristle filaments 4. For connecting to the bristle carrier 2, the bristle filaments 4, by way of their fused fastening-proximal ends 6, are pressed against the heated bristle carrier 2 by the pusher 26 of the brush manufacturing device 18, and thus are fastened to the bristle carrier 2.

For cooling the bristle carrier 2 after the bristle filaments 4 have been fastened to the bristle carrier 2, the brush manufacturing device 18 moreover has a cooling device 31. The cooling device 31 is specified to cool the bristle carrier 2 disposed in the mold 16.

According to FIG. 11, the brush manufacturing device 18 moreover has a magazine 32 in which a supply of loose bristle filaments 33 is disposed.

Bristle bundles 10 can be separated from the supply of loose bristle filaments 33 in the magazine 32 with the aid of a separating device 34 of the brush manufacturing device 18. The bristle bundles 10 can be brought into their desired target shape in the bristle complement 3 of the brush 1 to be manufactured with the aid of a bundle forming unit 35. The bristle bundles 10 from the bundle forming unit 35 are transferred to the filament holder 30 and fixed in the receptacle holes 38 formed as passage holes by way of the clamping mechanism 39.

The brush manufacturing device 18 has a dispensing device 40 for dispensing primer onto bristle filaments 4 and/or bristle carriers 2. Prior to connecting the bristle filaments 4 to the bristle carriers 2, primer can be dispensed onto bristle filaments 4 and/or bristle carriers 2 in this way. A primer can facilitate the production of a reliable connection between bristle filaments 4 and bristle carriers 2 according to the method described above.

Furthermore, bristle carriers 2 and bristle filaments 4 which contain at least one additive which improves the connection between the bristle carriers 2 and the bristle filaments 4 can be used when carrying out the method. Additives and primers which increase the grafts of the plastics material connection between the bristle carriers 2 and the bristle filaments 4 are advantageous.

FIG. 14 shows how the finished brush 1 after cooling the bristle carrier 2 is lifted out of the mold 16 by the lifting device 36. The bristle complement 3 is now connected to the bristle carrier 2 of the brush 1.

The invention focuses on improvements in the technical field of brush manufacturing, and relates, inter alia, to a brush 1 which has a bristle carrier 2 having a receptacle depression 5 which, when fastening bristle filaments 4 to the bristle carrier 2, is filled by fused filament material of fastening-proximal ends 6 of the bristle filaments 4 of the brush 1 to be manufactured.

### LIST OF REFERENCE SIGNS

1 Brush
2 Bristle carrier, brush head
3 Bristle complement
4 Bristle filaments
5 Receptacle depression
6 Fastening-proximal ends of 4
7 Neck portion
8 Handle
9 Reinforcement rib
10 Bristle bundle
11 Carrier plate
12 Surface of 11
13 Brush surface
14 Periphery
15 Cutout in 15
16 Mold
17 Mold wall
18 Brush manufacturing device
19 Heating device
20 Heating area for 6
21 Heating area for 2
22 Heating element
23 Temperature sensor
24 Control unit
25 Profiling device
26 Pusher, profiling tool
27 Cleaning side
28 Counter-profiling tool
29 Fastening side
30 Filament holder
31 Cooling device
32 Magazine
33 Supply of loose bristle filaments
34 Separating device
35 Bundle forming unit
36 Lifting device
37 Hole pattern of 30
38 Receptacle hole in 30
39 Clamping mechanism of 30
40 Dispensing device for primer

1. A method for manufacturing a brush (1) having a bristle carrier (2) and a bristle complement (3) of bristle filaments (4), the method comprising:
heating the bristle carrier (2) and fastening-proximal ends (6) of the bristle filaments (4) of the bristle complement (3); and
fusing the fastening-proximal ends (6) of the bristle filaments (4), whereupon the bristle carrier (2) and the bristle filaments (4) of the bristle complement (3) are connected to one another.

2. The method as claimed in claim 1, wherein the bristle carrier (2) and fastening-proximal ends (6) of the bristle filaments (4) of the bristle complement (3) are heated to different temperatures.

3. The method as claimed in claim 1, wherein at least one of a) the bristle carrier (2) and the bristle filaments (4) are composed of materials which are compatible for a mutual materially integral connection, or are composed of a same material which is compatible for a mutual materially integral connection, b) at least one of the bristle carrier (2) or bristle filaments (4) is used which contains at least one additive that simplifies and/or improves a connection between the bristle carrier (2) and bristle filaments (4), or c) prior to connecting the bristle filaments (4) to the bristle carrier (2) a primer as a bonding agent is applied to at least one of the bristle filaments (4) or the bristle carrier (2).

4. The method as claimed in claim 1, further comprising generating at least one carrier plate (11) which connects the bristle filaments (4) of one or of a plurality of bristle bundles (10) and/or a plurality of bristle bundles (10), or all bristle bundles (10), of the bristle complement (3) to one another by fusing the fastening-proximal ends (6) of the bristle filaments (4).

5. The method as claimed in claim 1, wherein the bristle carrier (2) is heated to a lower temperature than the fastening-proximal ends (6) of the bristle filaments (4).

6. The method as claimed in claim 1, further comprising inserting the bristle carrier (2) for connecting the bristle filaments (4) to the bristle carrier (2) into a mold (16) which has a mold wall (17) that at least in portions laterally surrounds the bristle carrier (2).

7. The method as claimed in claim 1, further comprising pressing the bristle filaments (4) for connecting to the bristle carrier (2) by way of the fused fastening-proximal ends (6) thereof against the heated bristle carrier (2), or pressing the heated bristle carrier (2) against the fused fastening-proximal ends (6) of the bristle filaments (4), and cooling the bristle carrier (2) after connecting to the bristle filaments (4).

8. A brush manufacturing device (18) for manufacturing brushes (1) having a bristle carrier (2) and a bristle complement (3) of bristle filaments (4), the brush manufacturing device (18) comprising:
a heating device (19) that is adapted to heat fastening-proximal ends (6) of bristle filaments (4) of the bristle complement (3) and the bristle carrier (2) to which the bristle filaments (4) of the bristle complement (3) are to be connected, in order to fuse the fastening-proximal ends (6) of the bristle filaments (4).

9. The brush manufacturing device (18) as claimed in the claim 8, wherein the heating device (19) comprises first and second heating areas (20, 21) of which the first heating area (20) is provided for heating the fastening-proximal ends (6) of bristle filaments (4) of the bristle complement (3) of the brush (1) to be manufactured, and the second heating area (21) is provided for heating the bristle carrier (2) of the brush (1) to be manufactured, to which bristle carrier (2) the bristle filaments (4) of the bristle complement (3) are to be connected, and the heating device (19) is adapted to heat the fastening-proximal ends (6) of the bristle filaments (4) and the bristle carrier (2), and to fuse the fastening-proximal ends (6) of the bristle filaments (4) and not the bristle carrier (2).

10. The brush manufacturing device (18) as claimed in claim 9, wherein the heating device (19) is adapted to heat the fastening-proximal ends (6) of the bristle filaments (4) and the bristle carrier (2) to different temperatures.

11. The brush manufacturing device (18) as claimed in claim 10, wherein the heating device (19) is adapted to heat the heating areas (20, 21) to different temperatures.

12. The brush manufacturing device (18) as claimed in claim 11, wherein at least one of a) the heating device (19) is adapted to heat the first heating area (20) to a temperature that is sufficient to fuse the fastening-proximal ends (6) of the bristle filaments (4), or b) the heating device (19) is adapted to heat the second heating area (21) to a temperature that is sufficient to heat the bristle carrier (2) to a temperature below a melting temperature thereof.

13. The brush manufacturing device (18) as claimed in claim 9, wherein a spacing between the first heating area (20) and a position which is predefined by the brush manufacturing device (18) and in which the fastening-proximal ends (6) of the bristle filaments (4) are arranged for heating is larger than a spacing between the second heating area (21) and a position which is predefined by the brush manufacturing device (18) and in which the bristle carrier (2) is arranged for heating.

14. The brush manufacturing device (18) as claimed in claim 9, wherein the first and second heating areas (20, 21) are disposed on a common heating element (22).

15. The brush manufacturing device (18) as claimed in claim 9, wherein the heating device (19) comprises a controller (24) configured for feedback-control of the temperatures of the first and second heating areas (20, 21), and at least one temperature sensor (23) for detecting and feedback-controlling the temperature of at least one of the first or second heating areas (20, 21).

16. The brush manufacturing device (18) as claimed in claim 9, further comprising a mold (16) for receiving and supporting the bristle carrier (2) when connecting the bristle carrier (2) to the bristle filaments (4) of the bristle complement (3), and a dispensing device (40) for dispensing primer onto at least one of the bristle filaments (4) or the bristle carriers (2).

17. The brush manufacturing device (18) as claimed in claim 9, further comprising at least one of a) a filament holder (30) for holding, the bristle filaments (4) of the bristle complement (3), b) a cooling device (31) for cooling the bristle carrier (2), or c) a pusher (26) which is adapted to press the bristle filaments (4) of the bristle complement (3), by way of fused fastening-proximal ends (6), against a heated bristle carrier (2), or is adapted to press a heated one of the bristle carriers (2) against fused ends (6) of the bristle filaments (4).

18. The method as claimed in claim 1, wherein the bristle carrier (2) and the bristle filaments (4) of the bristle complement (3) are materially integrally connected to one another.

19. The method as claimed in claim 1, wherein the bristle carrier (2) is heated to a temperature below a melting temperature thereof.

20. The brush manufacturing device (18) as claimed in claim 9, wherein each of the first and second heating areas (20, 21) is assigned at least one temperature sensor (23).
